(19) United States
(12) Patent Application Publication
(10) Pub. No.: US 2008/0134344 A1
(43) Pub. Date: Jun. 5, 2008

(54) RESTRICTING ACCESS TO CALENDAR ENTRIES

(76) Inventor: GERALD FRANCIS MCBREARTY, Austin, TX (US)

Correspondence Address: IBM CORP (YA);C/O YEE & ASSOCIATES PC, P.O. BOX 802333, DALLAS, TX, 75380, US

(21) Appl. No.: 11/566,100

(22) Filed: Dec. 1, 2006

(51) Int. Cl. H04L 9/32

(52) U.S. Cl. 726/28

(57) ABSTRACT

The illustrative embodiments provide a computer implemented method, an apparatus, and a computer usable program product for restricting access to a calendar. An engine receives a request from a user to view a set of dates in the calendar. Responsive to receiving the request, the engine determines an access level for the user that identifies a range of viewable dates available to the user. Responsive to determining the access level, the engine presents a limited view of the calendar that comprises the set of dates within the range of viewable dates.

### BACKGROUND OF THE INVENTION

1. Field of the Invention

The present invention relates generally to an improved data processing system, and in particular to a method and apparatus for managing access to a calendar. Still more particularly, the present invention relates to a computer implemented method, an apparatus, and a computer program usable product for restricting access to a calendar.

2. Description of the Related Art

Currently, calendar owners grant other users the privilege to view information contained within the owner's calendar. Calendar owners can restrict who has access to the calendar. Calendar owners also have a limited ability to restrict the information to which the user has access. This limited ability typically includes the option of allowing a user to view all event information recorded in a calendar or the option of only seeing that the calendar owner is busy at a particular event time. Calendar owners are not provided the option of restricting calendar information based on dates or even to place a time limit on how long the information is available to the user. Additional concerns arise when a calendar owner changes departments or moves to a new organization within a business entity. The concern is more so if the information recorded in the calendar is confidential to the user in either the owner's old or new department.

Currently, calendar owners scrub a calendar when leaving a particular department. In other words, calendar owners delete all entries which the owner does not wish users in the old or new department to access. This process is very time-consuming and cumbersome. Furthermore, in some instances, the information in the calendar cannot be deleted and needs to be maintained for a period of time after the calendar owner leaves the department.

### SUMMARY OF THE INVENTION

The illustrative embodiments provide a computer implemented method, an apparatus, and a computer usable program product for restricting access to a calendar. An engine receives a request from a user to view a set of dates in the calendar. Responsive to receiving the request, the engine determines an access level for the user that identifies a range of viewable dates available to the user. Responsive to determining the access level, the engine presents a limited view of the calendar that comprises the set of dates within the range of viewable dates.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is pictorial representation of a network of data processing systems, in which illustrative embodiments may be implemented;

FIG. 2 is a block diagram of a data processing system, in which illustrative embodiments may be implemented;

FIG. 3 illustrates a calendar management system, in accordance with an illustrative embodiment;

FIG. 4 is an example range of viewable dates and data in a calendar, in accordance with an illustrative embodiment;

FIG. 5 illustrates an access level table, in accordance with an illustrative embodiment;

FIG. 6 is an example access level request, in accordance with an illustrative embodiment;

FIG. 7 is a flowchart of a process for restricting access to a calendar, in accordance with an illustrative embodiment; and

FIG. 8 is a flowchart depicting a process for requesting access to a calendar, in accordance with an illustrative embodiment.

### DETAILED DESCRIPTION OF THE PREFERRED EMBODIMENT

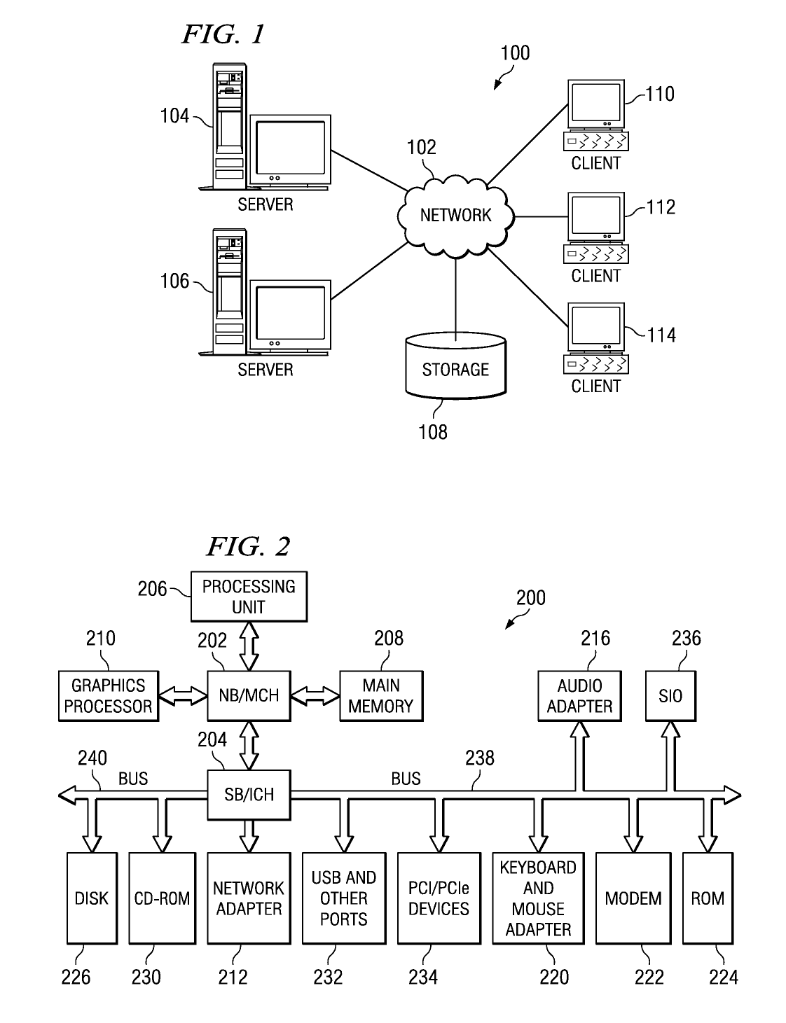

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications, to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP. Microsoft and Windows are trademarks of Microsoft Corporation in the United States, other countries, or both. An object-oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and the above-described examples are not meant to imply architectural limitations. For example, data processing system 200 also may be a tablet computer, a laptop computer, or a telephone device in addition to taking the form of a PDA.

The illustrative embodiments provide a computer implemented method, an apparatus, and a computer usable program product for restricting access to a calendar. An engine receives a request from a user to view a set of dates in the calendar. In these examples, the set of dates can be one or more dates. The engine determines an access level for the user. The access level identifies a range of viewable dates available to the user. The range of viewable dates may be at least one of a single date, a plurality of dates, a time frame, a date range, or a plurality of date ranges. In response to determining the access level, the engine presents a limited view of the calendar to a user. In one embodiment, the limited view of the calendar comprises a set of dates within the range of viewable dates. In another embodiment, the limited view of the calendar comprises the range of viewable dates.

In one embodiment, the limited view of the calendar also includes at least one data entry that is recorded in the range of viewable dates. The restriction engine allows the user to access the at least one date entry when the user accesses the limited view of the calendar. In another embodiment, the engine can set an expiration date for when the user can access the limited view of the calendar. When the expiration date is reached, the engine removes the user's access to the limited view of the calendar.

In yet another embodiment, the user can request a change in access level from the owner of the calendar. A change in access level can be a new request for access or a request to update the existing access level. The request for access can request to increase or decrease the range of viewable dates. The engine receives a request from the user to change the access level for the user. In response to receiving an acknowledgment to accept the request to change the access level, the engine updates automatically the access level for the user. To update automatically, the engine fetches the user identification and a requested range of viewable dates from the request to change the access level. The engine then stores the user identification and the requested range of viewable dates in a storage device. The engine then presents the requested range of viewable dates to the user.

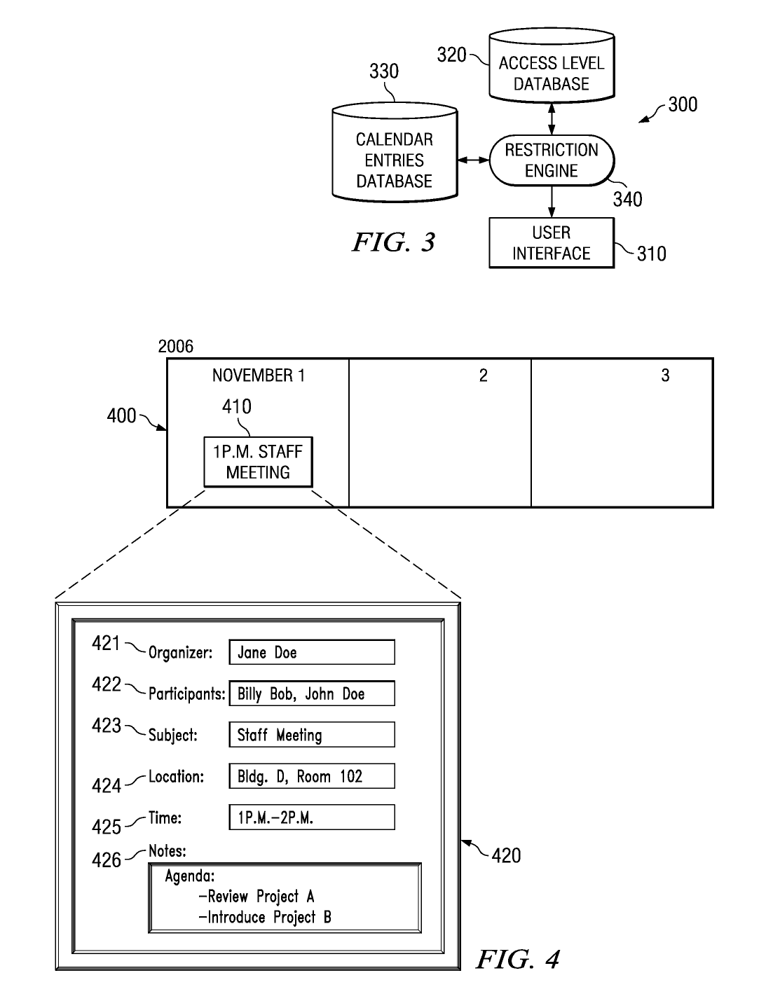

FIG. 3 illustrates a calendar management system, in accordance with an illustrative embodiment. Data processing system 300 is a system for managing a calendar for a calendar owner. Data processing system 300 can be implemented as client 110, 112, or 114 of FIG. 1 or as data processing system 200 of FIG. 2. In the illustrative embodiment, data processing system 300 is a computer. However, data processing system 300 can also be a personal digital assistant (PDA), a wireless mobile telephone, or any other small computer system.

Data processing system 300 includes user interface 310, access level database 320, calendar entries database 330, and restriction engine 340. In the illustrative embodiment, the components in data processing system 300 are implemented as a software only embodiment. However, in alternative embodiments, the components in data processing system 300 can also be implemented as a hardware only embodiment or as a combination hardware and software embodiment.

User interface 310 connects to restriction engine 340. A calendar owner interfaces with user interface 310 to manage access to the owner's calendar. User interface 310 can be implemented as any graphical user interface, including but not limited to a browser instance, a toolbar, a drop-down menu in a window, or any combination thereof. In the illustrative embodiment, an owner manages the owner's calendar using a drop-down menu.

Access level database 320 also connects to restriction engine 340. Access level database 320 stores the access level for other users to view the owner's calendar. In particular, access level database 320 stores the range of viewable dates that are available to another user. A range of viewable dates can be a single date or a number of dates in a calendar. The number of dates can be consecutive or non-consecutive dates. Additionally, the number of dates can also be multiple ranges of dates. The range of viewable dates can also be a range of times within a single date or within a number of dates. Furthermore, the range of viewable dates can include partial dates and can be bound by times within the dates. For example, the range of viewable dates can be from 12 A.M. on Feb. 13, 2006 to 3 P.M. on Feb. 16, 2006.

In the illustrative embodiment, the range of viewable dates is the dates in a calendar for which another user is granted rights to view, read, and modify. In one embodiment, the range of viewable dates only includes the dates in the calendar. In another embodiment, the range of viewable dates also includes other information or data entries stored for the identified range of viewable dates. Examples of the data entries include but are not limited to notes, call-in numbers, meeting information, and attachments. Furthermore, in other embodiments, the range of viewable dates may also restrict the rights granted to another user to only view the viewable dates, only read the information in the viewable dates, or only view and read but not modify the data entries in the range of viewable dates.

Access level database 320 is any storage device and can be implemented in the main memory, similar to main memory 208 of FIG. 2, or a hard disk, similar to disk 226 of FIG. 2, of data processing system 300. Access level database 320 can store data in any format, including but not limited to a table, a flat file, an extensible markup language (XML) file, a relational database management system, or any combination thereof. In the illustrative embodiment, access level database 320 stores data in a table.

Access level database 320 includes a list of user identifications and corresponding access levels for each user listed in access level database 320. The user identification for each user can be any type of identification, including but not limited to the name, the email address, the single sign-on identification, or another unique identification assigned to a user. The illustrative embodiment is not limited to the listed examples, and one of ordinary skill in the art can identify a variety of other types of user identifications which will not deviate from the scope of the illustrative embodiments.

Access level database 320 also identifies the different access levels for the different users. Each level in access level database 320 can include, for example, no viewable dates, at least one viewable date, a plurality of viewable dates, a range of viewable dates, or all dates in a calendar. Each level can also include well-defined start and stop dates in the range of viewable dates. The start date is the beginning date from which the range of viewable dates begins, while the stop date is the date at which the range of viewable dates ends. However, in an alternative embodiment, each level can also be defined as a number of individual, non-consecutive viewable dates. In yet another embodiment, each level can be a combination of individual, non-consecutive viewable dates and a range of viewable dates.

Each access level in access level database 320 can be divided in a variety of ways and can be based on a variety of criteria. For example, different access levels can be assigned based on the role of the user in an organization. For example, a senior engineer may have access to more viewable dates than a junior engineer, or a professional assistant may have access to all dates in the calendar while a project manager may have access only to a single viewable date. In another example, the different access levels can be based on the security clearance level of a particular user. Thus, a user with a high security clearance level may have access to a large range of viewable dates, while another user with a medium security clearance level may have access only to a medium range of viewable dates.

In yet another example, the different access levels may be based on the group type or the department in which the user works. For example, consider that the calendar owner moved from the software engineering group to the hardware engineering group. In this example, all users remaining in the software engineering group can view all dates during which the calendar owner worked in the software engineering group. On the other hand, all users in the hardware engineering group will only have access to all dates beginning when the calendar owner moved to the hardware engineering group. Thus, in this example, each group has defined start and stop viewable dates, and each group is limited to the time when the calendar owner works within the department.

In yet another embodiment, each user identified in access level database 320 has an individually defined level of access. In other words, the range of viewable dates is different for each user listed in access level database 320, and the access levels are not grouped. In the illustrative embodiment, each access level in access level database 320 is based on the user group from which the user of database 320 works and has a range of viewable dates that includes definite start and stop dates.

Access level database 320 can be created by the calendar owner, be a default setting, or be created by an administrator of the network to which data processing system 300 is connected. The calendar owner can also modify existing data within access level database 320. In the illustrative embodiment, in modifying, the calendar owner has the option of granting another user access to the calendar, of deactivating another user's access to the calendar, of increasing the range of viewable dates available to another user, or of decreasing the range of viewable dates available to another user.

Calendar entries database 330 connects to restriction engine 340 and stores data from the calendar in data processing system 300. Calendar entries database 330 is any storage device and can be implemented in the main memory, similar to main memory 208 of FIG. 2, or a hard disk, similar to disk 226 of FIG. 2, of data processing system 300. Calendar entries database 330 can also be a central, networked storage unit, such as storage 108 of FIG. 1. Calendar entries database 330 can store data in any format, including but not limited to a table, a flat file, an extensible markup language (XML) file, a relational database management system, or any combination thereof. In the illustrative embodiment, calendar entries database 330 is a central, networked storage unit and stores data in a flat file.

Calendar entries database 330 includes the calendar and all data entered into the calendar for data processing system 300. The calendar can be any software program which allows a user to schedule events, to record data, and to share the data stored in the software program with other users. Example calendars include, but are not limited to, the Lotus® Notes® and Microsoft Outlook calendars. Lotus® and Notes® are trademarks of International Business Machines Corporation in the United States, other countries, or both. Microsoft® and Outlook® are trademarks of Microsoft Corporation in the United States, other countries, or both.

The data recorded in calendar entries database 330 can include any information regarding a scheduled event, including but not limited to the time and date of the scheduled event, a list of participants, any notes regarding the scheduled event, or any notes recorded during the scheduled event. A scheduled event can be any activity or meeting recorded in the calendar. In the illustrative embodiment, a user who is granted access to the date on which a scheduled event occurs also has access to view all data recorded for the scheduled event.

Restriction engine 340 can be executed in a processing unit, similar to processing unit 206 of FIG. 2. Restriction engine 340 executes instructions to limit the view of a calendar for an identified user based on the access level of the identified user. In one embodiment, the limited view of the calendar is the set of dates within the range of viewable dates. The set of dates is the dates the identified user is requesting to view. The set of dates can be one or more dates. The range of viewable dates is all the dates that are available to the identified user. Thus, the range of viewable dates is the dates for which the calendar owner has granted rights to the identified user. Thus, in another embodiment, the limited view of the calendar is the range of viewable dates.

In use, in the illustrative embodiment, restriction engine 340 receives a request from another user to view a set of dates in the calendar stored in calendar entries database 330. In response to the request, restriction engine 340 identifies the user identification for the user requesting access to the calendar. After identifying the user, restriction engine 340 searches access level database 320 to locate the user identification and the corresponding access level for the identified user. Restriction engine 340 then identifies the range of viewable dates associated with the corresponding access level. Restriction engine 340 then locates the range of viewable dates and all data entries recorded for the range of viewable dates in calendar entries database 330. In one embodiment, restriction engine 340 further identifies the set of dates and all the data entries associated with the set of dates within the range of viewable dates. Restriction engine 340 then formats the set of dates into a human-readable form and presents the set of dates to the identified user. In another embodiment, restriction engine 340 formats and presents the entire range of viewable dates to the user.

In one embodiment, another user can request access to the calendar or request additional access to the calendar. In use, in this embodiment, the other user submits a request for access to the calendar to data processing system 300. In the request, the requesting user provides the user identification for the requesting user and the requested range of viewable dates. Restriction engine 340 receives the request and presents the request to the calendar owner. The calendar owner can either accept or decline the request for access. If the calendar owner accepts the request and the request is from a new user, restriction engine 340 creates a new entry in access level database 320. Restriction engine 340 then fetches and copies the user identification and the range of viewable dates from the request into the corresponding entries in access level database 320. If, on the other hand, the other user is requesting additional access to the calendar, restriction engine 340 then deletes and replaces the previous range of viewable dates with the new range of viewable dates. Restriction engine 340 then extracts the data associated with the range of viewable dates from calendar entries database 330. Restriction engine 340 then formats and presents the data to the other user.

In an alternative embodiment, the calendar owner can also modify the range of viewable dates requested by the other user. In other words, the calendar owner can grant more or fewer dates that the other user can view in the limited view of the calendar than the other user requested. Furthermore, the calendar owner can set an expiration date, which limits the length of time that the other user has to access the range of viewable dates. After the expiration date, the other user cannot view the data in the calendar associated with the range of viewable dates.

Data processing system 300 is not limited to the illustrative embodiment. For example, data processing system 300 may include more or fewer components. Additionally, other data may also be stored in access level database 320 and calendar entries database 330.

FIG. 4 is an example range of viewable dates and data in a calendar, in accordance with an illustrative embodiment. Range of viewable dates 400 can be implemented in data processing system 300 and stored in calendar entries database 330 of FIG. 3. Range of viewable dates 400 is a graphical representation of a calendar that may be displayed to a user on any electronic display, such as a computer screen.

Range of viewable dates 400 is a limited view of a calendar that may be presented to a user. The limited view of the calendar is based on the access level of the user. The access level for the user determines the range of viewable dates available to the user. In the illustrative embodiment, a user is granted access to view the entries recorded from November 1 through Nov. 3, 2006.

In the illustrative embodiment, event 410 is recorded on Nov. 1, 2006. Event 410 indicates that a staff meeting is scheduled for 1 P.M. on Nov. 1, 2006. Graphical user interface 420 is an expanded window for event 410 and provides detailed information regarding event 410. In the illustrative embodiment, graphical user interface 420 lists organizer 421, participants 422, subject 423, location 424, time 425, and notes 426. In the illustrative embodiment, organizer 421 is “Jane Doe”, and participants 422 are “Billy Bob” and “John Doe”. Subject 423 of event 410 is “staff meeting” and location 424 is “Bldg. D, Room 102”. Time 425 for event 410 is “1 P.M.-2 P.M.”. Notes 426 illustrates an “agenda” for event 410. The “agenda” includes “review Project A” and “introduce Project B”.

In the illustrative embodiment, a user with access to range of viewable dates 400 has access to all information available between Nov. 1 through Nov. 3, 2006. The user can view, read, and modify any information presented. For example, the user can add additional events similar to event 410 to range of viewable dates 400. The user can also delete event 410 or even edit the information in graphical user interface 420. In another embodiment, the user may be limited to only viewing range of viewable dates 400 and may be unable to view graphical user interface 420. In yet another embodiment, the user may be limited to only viewing and not editing the information presented in range of viewable dates 400.

The illustrative embodiments are not limited to the illustrated example. For example, range of viewable dates 400 can include more or fewer dates in the calendar. Additionally, more events like event 410 can also be included in range of viewable dates 400. Furthermore, more, less, or different information can be presented in graphical user interface 420. Moreover, in another embodiment, range of viewable dates 400 can also be a set of dates within a range of viewable dates.

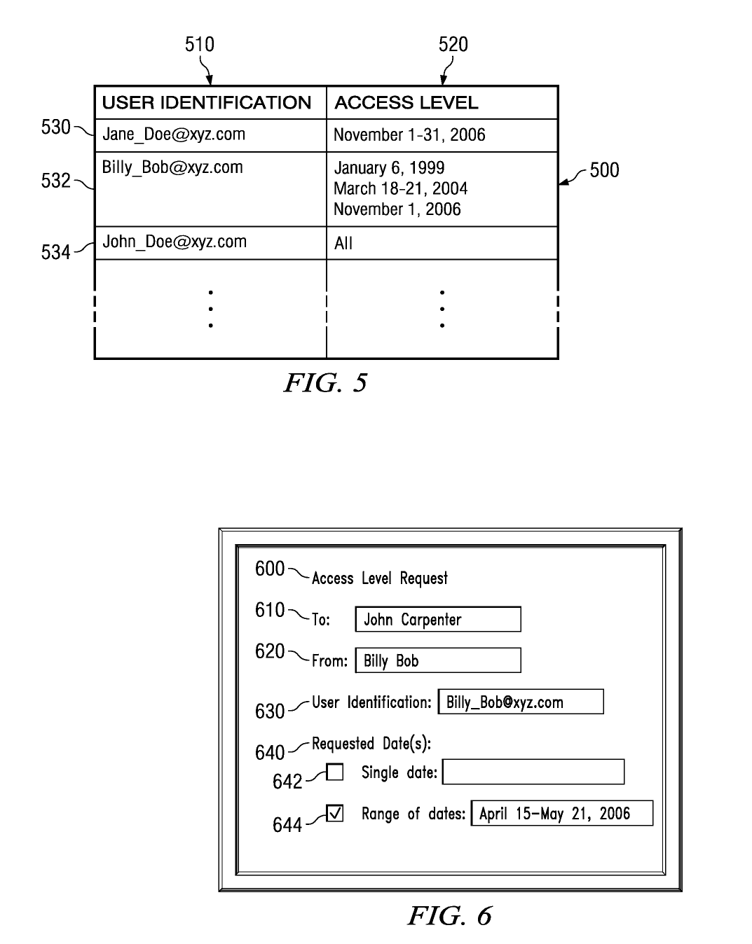

FIG. 5 illustrates an access level table, in accordance with an illustrative embodiment. Access level table 500 can be implemented in access level database 330 of FIG. 3. Access level table 500 identifies the access level to a calendar for a particular user.

Access level table 500 includes user identification column 510 and access level column 520. User identification column 510 lists the users who have access to the calendar. In the illustrative embodiment, user identification column 510 lists users using the email address for the user. However, in another embodiment, user identification column 510 can list the user's name, single sign-on identification, or any other unique identification for the user.

Access level column 520 lists the viewable dates or the range of viewable dates available to the user identified in user identification column 510. In the illustrative embodiment, the dates are listed in a month, day, and year format. However, in other embodiments, the dates may be listed in any other format recognized by one of ordinary skill in the art.

In the illustrative embodiment, row 530 identifies “Jane_Doe@xyz.com” with an access level of “Nov. 1-31, 2006”. Thus, in the illustrative embodiment, user Jane Doe has a range of viewable dates of November 1 through Nov. 31, 2006. In row 532, “Billy_Bob@xyz.com” has an access level of “Jan. 6, 1999”, “Mar. 18-21, 2004”, and “Nov. 1, 2006”. Thus, in the illustrative embodiment, user Billy Bob has a combination of single viewable dates and a range of viewable dates. In row 534, “John_Doe@xyz.com” has access to “all” information recorded in the calendar. In other words, user John Doe is not limited to a specific viewable date or range of viewable dates, but can access information on any date in the calendar.

The illustrative embodiments are not limited to the illustrative example. For example, access level column 520 can be divided into categories, with each category assigned a specific viewable date or range of viewable dates. Additionally, the viewable dates listed in row 532 can be stored in several columns instead of as one entry in row 532 in access level column 520. Furthermore, access level table 500 can include more or fewer columns and rows and include more or less information.

FIG. 6 is an example access level request, in accordance with an illustrative embodiment. Access level request 600 can be implemented in data processing system 300. Access level request 600 is a graphical user interface in which another user can request access to a set of dates in a calendar. The set of dates is one or more dates.

Access level request 600 includes “To:” entry 610, “From:” entry 620, “User Identification:” entry 630, and “Requested Date(s):” entry 640. “To:” entry 610 indicates the owner of the calendar from whom the other user is requesting access. In the illustrative embodiment, “John Carpenter” is the owner of the calendar. “From:” entry 620 is the other user who is requesting access to the owner's calendar. In the illustrative embodiment, “Billy Bob” is requesting access to “John Carpenter's” calendar. “User Identification:” entry 630 is the user identification for the other user. In the illustrative embodiment, “Billy Bob's” user identification is “Billy_Bob@xyz.com”. “Requested Date(s):” entry 640 includes a single date or a range of dates for which the other user is requesting access. The other user can request single date 642, range of dates 644, or both. In the illustrative embodiment, “Billy Bob” is requesting a range of dates. Specifically, “Billy Bob” is requesting “April 15-May 21, 2006”.

The illustrative embodiments are not limited to the illustrative example. Access level request 600 can include more or less information. Access level request 600 can also be arranged in a different format. Additionally, user identification entry 630 can be in another form. Furthermore, requested date(s) entry 640 may not be divided into single date 642 and range of dates 644, but may include only a single entry for both options. Moreover, access level request 600 can be used by another user to request a change in the range of viewable dates. The change can be a new request by the user or a request to increase or decrease the range of viewable dates available to the user.

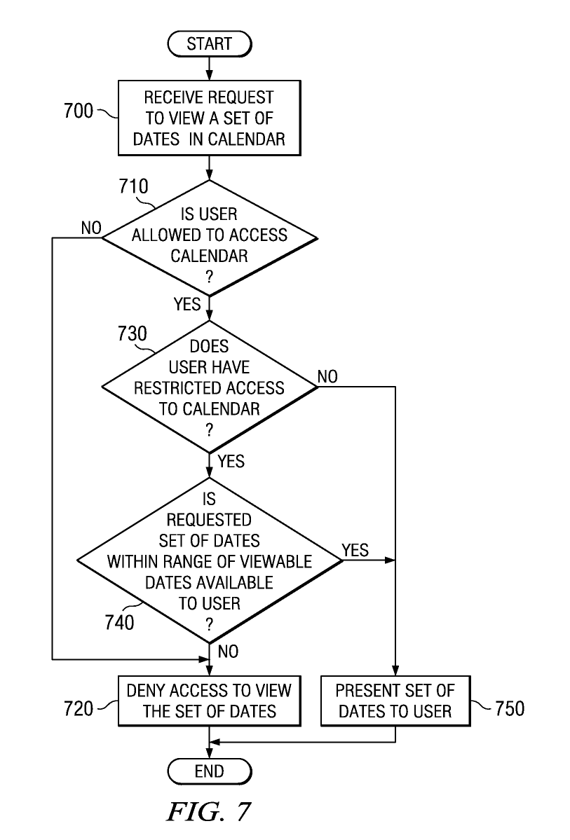

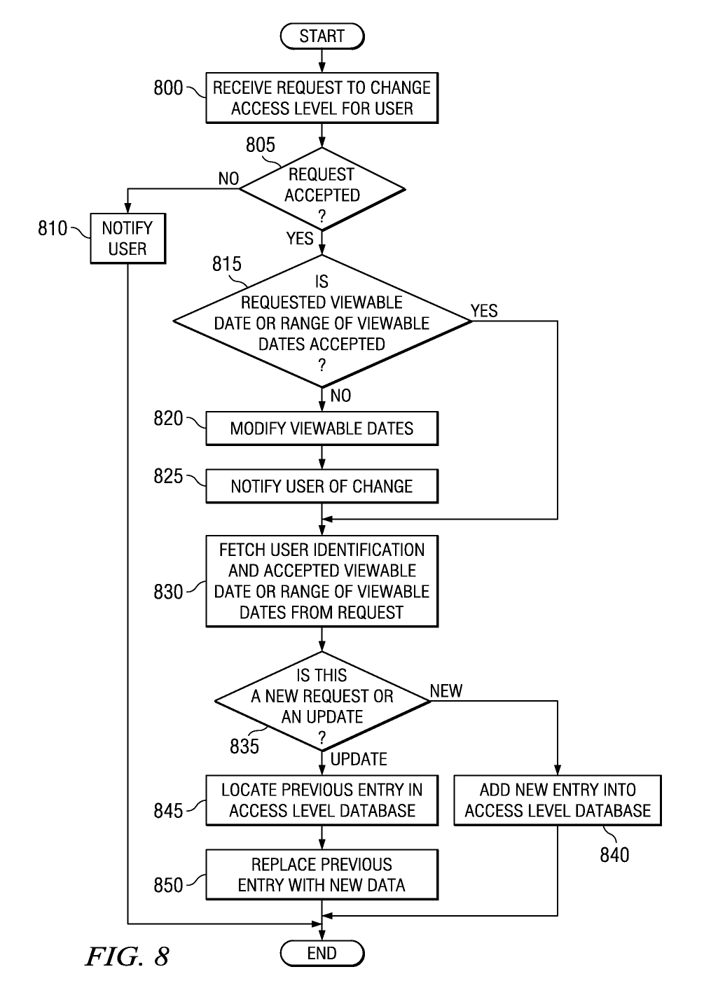

FIG. 7 is a flowchart of a process for restricting access to a calendar, in accordance with an illustrative embodiment. The following process is exemplary only and the order of the steps may be interchanged without deviating from the scope of the invention. The following process can be implemented in a restriction engine, similar to restriction engine 340 of FIG. 3.

The process begins with the restriction engine receiving a request to view a set of dates in a calendar (step 700). The restriction engine then determines whether the user is allowed to access the calendar (step 710). The restriction engine makes the determination by identifying the user in an access level database. If the user is not listed in the access level database (“no” output to step 710), then the user is denied access to view the set of dates (step 720), with the process terminating thereafter.

Returning to step 710, if the user is listed in the access level database (“yes” output to step 710), then the restriction engine determines whether the user has restricted access to the calendar (step 730). If the user has restricted access (“yes” output to step 730), the restriction engine then determines whether the set of dates requested by the user is within the range of viewable dates available to the user (step 740). If the set of dates is within the available range (“yes” output to step 740), then the restriction engine presents the set of dates to the user (step 750), with the process terminating thereafter.

Returning to step 740, if the set of dates is not within the available range (“no” output to step 740), then the user is denied access to view the set of dates (step 720), with the process terminating thereafter. Returning to step 730, if the user does not have restricted access to the calendar (“no” output to step 730), then the set of dates is presented to the user (step 750), with the process terminating thereafter.

FIG. 8 is a flowchart depicting a process for requesting access to a calendar, in accordance with an illustrative embodiment. The following process is exemplary only and the order of the steps may be interchanged without deviating from the scope of the invention. The following process can be executed in a restriction engine, similar to restriction engine 340 of FIG. 3.

The process begins with the restriction engine receiving a request to change the access level for a user (step 800). The request to change can be a new request or a request to update an existing access level for the user. The restriction engine then identifies whether the calendar owner accepts the request to change (step 805). If the calendar owner denies the request (“no” output to step 805), the restriction engine then sends a communication that notifies the user of the denied request (step 810), with the process terminating thereafter.

Returning to step 805, if the calendar owner accepts the request (“yes” output to step 805), the restriction engine then identifies whether the calendar owner has accepted the requested viewable date or range of viewable dates (step 815). If the viewable date or range of viewable dates is not accepted by the calendar owner (“no” output to step 815), then the calendar owner modifies the viewable dates (step 820). The restriction engine then sends a communication to the user that notifies the user of the change (step 825).

Returning to step 815 and step 825, if the requested viewable date or range of viewable dates is accepted by the calendar owner (“yes” output to step 815), then the restriction engine fetches the user identification and the accepted viewable date or range of viewable dates from the request to change (step 830). The restriction engine then determines whether the request to change is a new request or a request to update (step 835). To make the determination, the restriction engine identifies whether the user is listed in the access level database. If the user is not listed in the access level database (“new” output to step 835), then the restriction engine adds a new entry into the access level database (step 840), with the process terminating thereafter.

Returning to step 835, if the user is listed in the access level database (“update” output to step 835), then the access database locates the previous entry for the user in the access level database (step 845). The restriction engine then replaces the previous entry with the new data (step 850), with the process terminating thereafter.

Thus, the illustrative embodiments provide a computer implemented method, an apparatus, and a computer usable program product for restricting access to a calendar. An engine receives a request from a user to view a set of dates in the calendar. In these examples, the set of dates can be one or more dates. The engine determines an access level for the user. The access level identifies a range of viewable dates available to the user. The range of viewable dates may be at least one of a single date, a plurality of dates, a time frame, a date range, or a plurality of date ranges. In response to determining the access level, the engine presents a limited view of the calendar to a user. In one embodiment, the limited view of the calendar comprises a set of dates within the range of viewable dates. In another embodiment, the limited view of the calendar comprises the range of viewable dates.

In one embodiment, the limited view of the calendar also includes at least one data entry that is recorded in the range of viewable dates. The restriction engine allows the user to access the at least one data entry when the user accesses the limited view of the calendar. In another embodiment, the engine can set an expiration date on when the user can access the limited view of the calendar. When the expiration date is reached, the engine removes the user's access to the limited view of the calendar.

In yet another embodiment, the user can request a change in access level from the owner of the calendar. A change in access level can be a new request for access or a request to update the existing access level. The request for access can request to increase or decrease the range of viewable dates. The engine receives a request from the user to change the access level for the user. In response to receiving an acknowledgment to accept the request to change the access level, the engine updates automatically the access level for the user. To update automatically, the engine fetches the user identification and a requested range of viewable dates from the request to change the access level. The engine then stores the user identification and the requested range of viewable dates in a storage device. The engine then presents the requested range of viewable dates to the user.

The illustrative embodiments provide a calendar owner with the ability to restrict access to information in the calendar based on dates. Therefore, the calendar owner can define the time period and the type of information available to a user. The calendar owner can also limit the amount of time the information is available to the user.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for restricting access to a calendar, the method comprising:
receiving a request from a user to view a set of dates in the calendar;
responsive to receiving the request, determining an access level for the user that identifies a range of viewable dates available to the user; and
responsive to determining the access level, presenting a limited view of the calendar that comprises the set of dates within the range of viewable dates.

2. The computer implemented method of claim 1, wherein the limited view of the calendar comprises the range of viewable dates.

3. The computer implemented method of claim 1, further comprising:
setting an expiration date for when the user can access the limited view of the calendar; and
responsive to reaching the expiration date, removing access to the user to the limited view of the calendar.

4. The computer implemented method of claim 1, wherein the limited view of the calendar comprises at least one data entry recorded in the range of viewable dates, and wherein the computer implemented method further comprises:
allowing the user to access the at least one data entry when the user accesses the limited view of the calendar.

5. The computer implemented method of claim 1, further comprising:
receiving a request from the user to change the access level for the user; and
responsive to accepting the request to change the access level, updating automatically the access level for the user.

6. The computer implemented method of claim 5, wherein the step of updating automatically the access level for the user comprises:
fetching a user identification and an updated range of viewable dates from the request to change the access level;
storing the user identification and the updated range of viewable dates in a storage device; and
presenting the updated range of viewable dates to the user.

7. The computer implemented method of claim 5, wherein the request to change the access level is a request to increase or decrease the range of viewable dates.

8. A data processing system comprising:
a user interface;
an engine coupled to the user interface, wherein the engine receives a request from the user interface to view a set of dates in a calendar; and
a database coupled to the engine, wherein the database identifies an access level for a user in response to receiving the request, wherein the access level identifies a range of viewable dates in the calendar available to the user, and wherein the engine presents a limited view of the calendar that comprises the set of dates within the range of viewable dates.

9. The data processing system of claim 8, wherein the limited view of the calendar comprises the range of viewable dates.

10. The data processing system of claim 8, wherein the engine determines an expiration date for when the user can access the limited view of the calendar, and wherein the engine removes access to the user to the limited view of the calendar in response to reaching the expiration date.

11. The data processing system of claim 8, wherein the limited view of the calendar comprises at least one data entry recorded in the range of dates, and wherein the engine allows the user to access the at least one data entry when the user accesses the limited view of the calendar.

12. The data processing system of claim 8, wherein the engine receives a request from the user to change the access level for the user, and wherein the engine automatically updates the access level for the user in the database in response to accepting the request to change the access level.

13. The data processing system of claim 12, wherein the automatic updating by the engine comprises:
fetching a user identification and an updated range of viewable dates from the request to change the access level;
storing the user identification and the updated range of viewable dates in a storage device; and
presenting the updated range of viewable dates to the user.

14. A computer program product comprising a computer usable medium including computer usable program code for restricting access to a calendar, the computer program product comprising:
computer usable program code for receiving a request from a user to view a set of dates in the calendar;
responsive to receiving the request, computer usable program code for determining an access level for the user that identifies a range of viewable dates available to the user; and
responsive to determining the access level, computer usable program code for presenting a limited view of the calendar that comprises the set of dates within the range of viewable dates.

15. The computer program product of claim 14, wherein the limited view of the calendar comprises the range of viewable dates.

16. The computer program product of claim 14, further comprising:
computer usable program code for setting an expiration date for when the user can access the limited view of the calendar; and
responsive to reaching the expiration date, computer usable program code for removing access to the user to the limited view of the calendar.

17. The computer program product of claim 14, wherein the limited view of the calendar comprises at least one data entry recorded in the range of viewable dates, and wherein the computer program product further comprises:
computer usable program code for allowing the user to access the at least one data entry when the user accesses the limited view of the calendar.

18. The computer program product of claim 14, further comprising:
computer usable program code for receiving a request from the user to change the access level for the user; and
responsive to accepting the request to change the access level, computer usable program code for updating automatically the access level for the user.

19. The computer program product of claim 18, wherein the computer usable program code for updating automatically the access level for the user comprises:
computer usable program code for fetching a user identification and an updated range of viewable dates from the request to change the access level;
computer usable program code for storing the user identification and the updated range of viewable dates in a storage device; and
computer usable program code for presenting the updated range of viewable dates to the user.

20. The computer program product of claim 17, wherein the request to change the access level is a request to increase or decrease the range of viewable dates.
